(19) United States
(12) Patent Application Publication
(10) Pub. No.: US 2011/0005469 A1
(43) Pub. Date: Jan. 13, 2011

(54) Hanging toy for horses and animals

(76) Inventor: Jennifer Lynn Dean, Santa Cruz, CA (US)

Correspondence Address: Jennifer Lynn Dean, 1007 Broadway, Santa Cruz, CA, 95062, US

(21) Appl. No.: 12/803,646

(22) Filed: Jul. 1, 2010

Related U.S. Application Data
(60) Provisional application No. 61/269,920, filed on Jul. 1, 2009.

(51) Int. Cl. A01K 15/02; A01K 29/00

(52) U.S. Cl. 119/710

(57) ABSTRACT

To alleviate stall boredom, cribbing and other deleterious behaviors of many farm animals kept in stalls and pens, this invention provides entertainment and stimulates mental activity as well as food occupation. These key aspects of equine enrichment applies to any animal in limited living quarters that can benefit from such entertainment. Additionally, the ability for the owner to utilize any treat or food object of their choosing, as well as controlling the amount given, said animals' dietary needs and requirements will not be negatively affected by use of this invention and even improved.

### BACKGROUND

1. Field of the Invention

This invention relates generally to the field of equine toys and devices for entertainment and enrichment for horses, pets, and various farm animals. While best used and utilized by horses, it can also be used with goats, pigs and other suitable animals and pets.

2. Background of the Invention

Horses, pets, and other captive animals are often kept in stalls or similar structures for containment and housing. In many cases, these animals suffer from boredom and lack of intellectual stimulus. As a result, they can become lethargic, or in some cases, resort to a multiplicity of undesirable behaviors to include “cribbing”, chewing of wood and other materials found in their reachable vicinity, and apathy. There are many “toys” and objects available to attempt to address this, primarily for the purpose of entertaining these animals, however they vary in efficacy on the basis of the individual nature and preferences of the animal, as well as lacking in incentive for discovery or inquiry by said animal. The described invention solves this problem by offering “treats” or desirable enticements in the way of food or snacks to generate curiosity and interest.

Some existing “toys” and devices include balls or other similar structures which can be left in the stalls or pens occupied by the horses or animals, however no others are known to have a means to apply or attach food items of choice by the owner. While some are equipped with, or can be later purchased to equip with, a “salt lick” or similar medium desirable to the animals that are specifically designed to work with said device. In these cases, these mineral based treats can be high in sugar content or other elements not necessarily consistent with specific dietary needs of a given animal. This invention solves this issue by having holes of various sizes and shapes to allow the owner to insert various items such as carrots, apples, and other vegetables or fruits or snacks. By allowing the owner or user to insert their own treats, inserted items can comply with dietary needs of the animal. Additionally, no further purchases are necessary to continue use of this invention, unless it is broken or lost.

Due to the nature of construction and design of this described device, the animal must be creative in its attempts to retrieve the “treats” or inserted items. Because the device is hanging (by the provided means of an eye-bolt, handle, or similar structure), the inserted items cannot be easily removed by the animal, and thus promotes or requires improved tactile approaches to successfully retrieve the inserted items, as well as promoting mental activity to discover more efficient or easier ways to retrieve said inserted items. The animal can chew or break off the inserted items with their teeth, causing the remaining portions of the inserted item (remaining inside the device) to then fall to the ground.

### SUMMARY OF THE INVENTION

To address the limitations posed by the existing toys and similar objects, this invention has been designed to receive inserted edible or desirable items by way of holes and other through-penetrations (it will be understood that from this point on, the use of the term “holes” may apply to various shaped through-penetrations through the outer shell or shape of the device, that need not necessarily be “circular” in nature or appearance). The holes or penetrations are designed to retain the various items being inserted into them. To accommodate the need to retain items of varying densities and integrities, the shapes may often be triangular, “star-shaped” or threaded.

In one embodiment, the device is comprised of a cylinder, made from a plastic based material, such as PVC (Poly Vinyl Chloride), or similar material, with an end cap to enclose the top portion and to affix a hanging structure. This cap may be comprised of a similar material as the cylinder, or in another embodiment, be a molded feature of the cylindrical structure. The bottom portion of the cylinder is specifically left open such that when a portion of the inserted item is broken off or removed [by the animal] from the exterior of the device, the remaining portion of the inserted item is free to fall through the bottom of the structure and also claimed or received by the animal.

In one embodiment, a method for manufacturing the described device may include manual assembly. This would include a cylinder, an end cap, and an eye-bolt. The cylinder is cut to length, and the holes are cut into the surface of the cylinder. The cylinder needs to be thin walled (in a range of 1/32″ to 3/16″) if holes are cut without treads to retain the inserted materials. Some associative hardware is necessary for retaining the eye-bolt in place, through the end cap.

### BRIEF DESCRIPTION OF THE DRAWINGS

FIG. 1 is a cross sectional view of the device, in accordance with an embodiment of the device.

FIG. 2 is a perspective or dimensional view of the cylindrical embodiment of the invention displaying one version of the “holes” or “through penetrations”

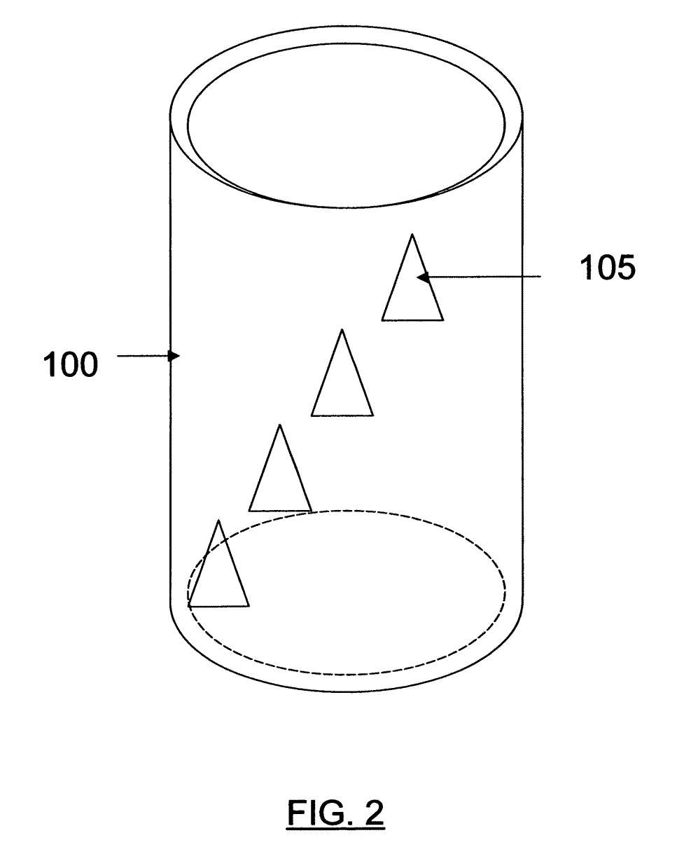

FIG. 3 is a diagram showing 4 variations of “holes” that can be made into the device.

FIG. 4 is a cross sectional view of another embodiment of the device.

### DETAILED DESCRIPTION OF THE PREFERRED EMBODIMENTS

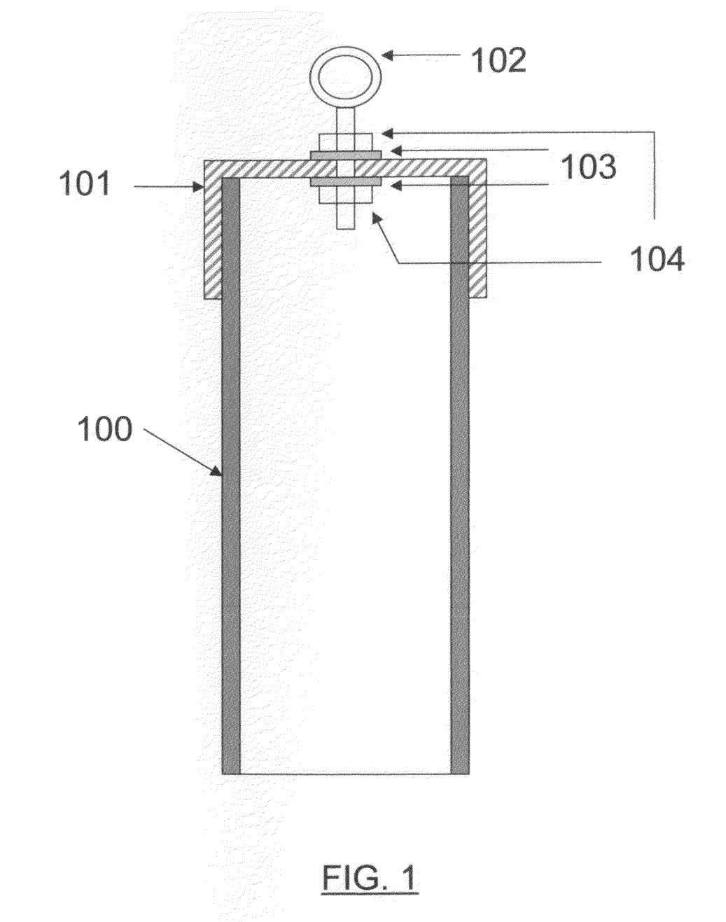

FIG. 1 illustrates one embodiment of the device. The cylinder structure 100 is attached to the cap structure 101. This can be held in place by way of a plethora of fastening devices (not shown) to include screws, rivets, epoxies and mastics, or heat treatment. Also shown in FIG. 1 is the cap 101, the eye-bolt hanging device 102, washers 103, and nuts 104. In some cases, it is best to use nylon threaded nuts, or steel nuts having nylon material in them, to help retain its position. In some cases, it is best to insert cylinder 100 into cap 101, held by friction, but without additional attachment means. In this configuration, if damage occurs to cylinder 100, it may be replaced separately. The friction holding cylinder 100 to cap 101 is sufficient to disallow the animal from separating the two parts.

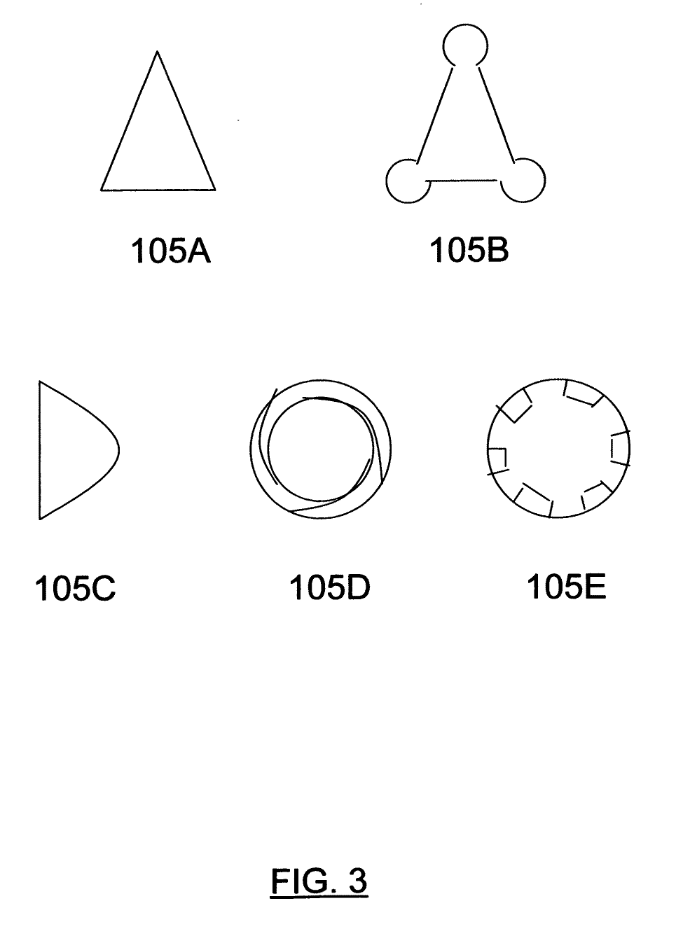

In an embodiment in which the device is used in conjunction with inserted items such as carrots and apples, the thickness of the material used for cylinder 100 needs to be appreciably thin to “cut into” the medium inserted. The thickness must also be sufficient to withstand some abuse by the animal using it. The wall thickness of the cylinder is in the range of 1/32″ to 3/16″ when using PVC as a material to create the cylinder. In the cases of utilizing thicker materials (of PVC or other plastics and polymers), it is necessary to tap threads into holes 105, such as 105D in FIG. 3, or provide different shaped holes, such as 105A-105E found on FIG. 3. Some hole shapes are best suited for certain inserted items, based upon the way the items have been prepared. In the case of carrots used as the inserted items, it's best to cut them into quarters, when viewed from an “end”, so that the cross section of the carrot is mostly triangular in appearance and profile. In this case, the triangular hole is most suitable for retaining the inserted item. The carrot piece is inserted into the provided hole in cylinder 100, then twisted (clockwise or counter-clockwise) causing the edges of the holes 105 in cylinder 100 to cut into the inserted carrot. This then retains the carrot, disallowing removal by simply pulling on it. The animal must then bite through the carrot or inserted object, receiving both the portion it has bitten, and the remainder of the inserted item that has fallen through the bottom of the device.

A plethora of shapes and sizes are suitable for the holes and penetrations. Amongst them, as found on FIG. 3, the triangular shapes 105A and 105B may work best for carrots, wherein 105B has its corners cut into (by way of small circular penetrations that allow for cutting edges at each end of the flat portions of the triangular holes. Hole 105C comprises a “D” shape wherein the flat edge of the “D” cuts into the inserted item for retentive purposes. Feature 105D found in FIG. 3, show a circular hole. This hole, however may have threads cut into it, to allow for retentive means of the inserted object. As yet a further option of the holes or penetrations 105E contains a circular opening, however with portions that protrude into the opening in such a way that it may retain an inserted object. In this case, the protruding portions are pliable or bendable and may hold the inserted item of their own force, or the inserted item may be twisted to allow the protruding splines or bladed features of 105E to cut into the surface of the inserted item. The splines or blades may be offset in such a way that they cause threads to be cut into the carrot or inserted item. They may be machined or formed in this fashion.

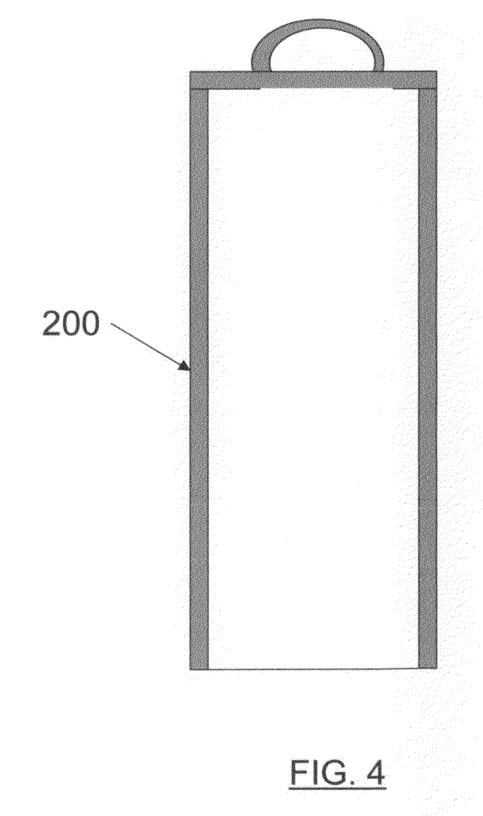

Yet another embodiment of the device includes an injection molded or otherwise fabricated device. This embodiment, found on FIG. 4, cylinder 200 is molded from a tool in either a single piece or two pieces that have been joined. This embodiment may include a handle that is formed or molded into it, requiring no additional steps in assembly or manufacturing. This embodiment may be formed of any number of plastic materials to include non-hydroscopic plastics, such as polypropylene and the like.

The above mentioned embodiment, described as a single piece or 2 pieces formed and/or molded may have the holes or penetrations formed into it, removing the additional step of punching or cutting holes into it for holding the inserted objects. This embodiment may include any of the described holes or penetrations found in FIG. 3.

Further embodiments include varying shapes to structure 100 or 200 described and presented in the figures. For example, particularly in the case of molded or formed structures; possible shapes may include that of a large apple, carrot, or other organic shapes.

The foregoing description of the embodiments of the invention is for the purpose of illustration; it is not intended to be exhaustive or to limit the invention to the precise forms disclosed. It can be appreciated by persons skilled in the relevant art that many modifications and variations are possible in light of the above teachings.

What's claimed is:

1. A hanging toy or treat device comprising:
a cylindrical object with a cap at one end; the other end being open or without a cap; the object having one or more holes or openings, for inserting food items and enticements for animals to retrieve.

2. The device of claim 1, wherein a first embodiment of the device includes one or more holes that are triangular in shape.

3. The device of claim 1, wherein the holes are star shaped; having features to the shape of said hole that point “inward” toward the center of the opening, so as to better retain inserted objects.

4. The device of claim 1 wherein the holes are threaded.

5. The device of claim 1 wherein the holes or openings vary in size, from ¼″ to 1½″ in diameter.

6. The device of claim 5, wherein a first embodiment of the device includes one or more holes that are triangular in shape.

7. The device of claim 5, wherein the holes are star shaped; having features to the shape of said hole that point “inward” towards the center of the opening, so as to better retain inserted objects.

8. The device of claim 5 wherein the holes are threaded.

9. The device of claim 5 wherein the holes are or openings comprise a combination of triangles, star shaped openings of claim 7, and threaded openings.

10. A hanging toy or treat device comprising:
a cylindrical object with a cap at one end; the other end being open or without a cap; the object having one or more holes or openings, for inserting food items and enticements for animals to retrieve. The device containing hardware for which to hang it from.

11. The device of claim 10 wherein the hardware for hanging the device comprises an “eye bolt” like structure fastened by washers and nuts to affix it to the cap.

12. A hanging toy or treat device comprising:
An object that is closed at one end; the other end being open or without a cap; the object having one or more holes or openings, for inserting food items and enticements for animals to retrieve. The device being formed or molded to include a hanging structure or feature.

13. The device of claim 12 wherein the structure is shaped like an apple.

14. The device of claim 12 wherein the structure is shaped like a carrot.

15. The device of claim 12 wherein the structure is substantially cylindrical.

16. The device of claim 12 wherein the holes are triangular.

17. The device of claim 12 wherein the holes are star shaped; having features to the shape of said hole that point “inward” toward the center of the opening, so as to better retain inserted objects.

18. The device of claim 12 wherein the holes are threaded.
